(19) United States
(12) Patent Application Publication
(10) Pub. No.: US 2026/0183769 A1
(43) Pub. Date: Jul. 2, 2026

(54) Box

(71) Applicant: Sartorius Liquid Handling oy, Helsinki (FI)

(72) Inventor: Ville Hintikka, Helsinki (FI)

(21) Appl. No.: 19/428,402

(22) Filed: Dec. 22, 2025

(30) Foreign Application Priority Data
Dec. 30, 2024 (EP) 24223714.7

(51) Int. Cl. B01L 9/00

(52) U.S. Cl. CPC B01L 9/543; B01L 2300/043; B01L 2300/123; B01L 2300/14

(57) ABSTRACT

According to an example aspect of the present invention, there is provided a box for disposable pipette tips, comprising: a base portion forming a container to receive the pipette tips therein; a cover portion movable to a closed configuration where the cover portion closes the base portion into a closed container; and a flexible hinge joining the base portion and the cover portion to each other.

### FIELD

The present application relates to packages for pipette tips.

### BACKGROUND

It is known to provide disposable pipette tips in plastic boxes with a hinged cover. The boxes are typically manufactured by injection moulding techniques, and the hinge structures are integrated to the injection-moulded box by mechanisms resulting in outwardly protruding shapes. Such hinge structures are easy to manufacture but are still disadvantageous in many respects. The product typically contains many protruding and complex shapes in its outer surfaces, which consume space during storage and also upon use in a laboratory setting. Protruding shapes are susceptible of being damaged or causing damage to adjacent products or to plastic protective films around the packages during transport. Managing a balance between robustness, opening angle range, and ease of operation of a hinge may be a very challenging task.

### SUMMARY OF THE INVENTION

The present invention is intended to overcome at least some of the disadvantages in the known plastic tip packages. The invention is defined by the features of the independent claims. Some specific embodiments are defined in the dependent claims.

According to a first aspect of the present invention, there is provided a box for disposable pipette tips, comprising: a base portion, a cover portion, and a flexible hinge. The base portion forms a container to receive the pipette tips therein. The cover portion is movable to a closed configuration where the cover portion closes the base portion into a closed container. The flexible hinge is formed of a deformable material and joins the base portion and the cover portion to each other.

At least some embodiments of the present invention may provide one or more of the following advantages:
Material savings may be achieved as the package may be small, which is advantageous particularly in connection with automated liquid handling robots.
The package may be more user-friendly as the locking of the cover can be released by one hand (or with a gripper) and therefore the cover is easy to open and close. Further, the cover may be used in two ways: in accordance with a hinge-lock principle, or alternatively as a detachable lockable cover, preferably detachable by one hand.
Picking tips directly from the package without any separate support may be possible.
The package may be space-saving since there are no protruding shapes, such as hinges or locking shapes. In this way the package may also be more robust and less susceptible to damage.
The package may be hermetically tight or sealed or gas-tight with an adhesive tape closing the seam between the base portion and the cover portion of the package. At the same time, the package may be easily taken into use by removing the tape.

### BRIEF DESCRIPTION OF THE DRAWINGS

FIG. 1 shows a cross-sectional view of an embodiment in which the box comprises a hinge manufactured by IML process;

FIG. 2 shows a cross-sectional view of a hinge mechanism realized by multicomponent injection moulding.

FIG. 3 shows an embodiment with an adhesive tape acting as a flexible hinge;

FIG. 4 shows an embodiment in which a tape runs along and above the seam between the cover and the base; and

FIG. 5 shows an embodiment in which the box comprises a tape which functions both as a hermetic sealing and as a hinge;

FIG. 6 show an example of an embodiment of a packet of pipette tips.

### EMBODIMENTS

The present application relates to a package or box for single-use pipette tips. The box comprises a base portion (or, simply, a base) and a cover portion (or, simply, a cover), which are connected to each other by means of a hinge part. The term “pipette tip” refers to a replaceable tip for a pipette. A pipette tip is intended to come in contact with a fluid to be transported and is typically disposable.

The base portion forms a container to receive pipette tips therein. The base portion may be in the form of an open-top box, for example. In a typical use case, the bottom side of the box rests on a substantially flat, horizontal surface. The base portion may be provided with a tray or a rack with a matrix of holes to hold a plurality of pipette tips. The cover portion forms a lid to the base portion. The cover portion is movable between an open configuration and a closed configuration. In the open configuration, the cover portion is not positioned on top the top side of the base portion and the pipette tips are directly accessible in the base portion. In the closed configuration, the cover portion is positioned on top of the base portion so that the cover portion closes the base portion into a closed container that completely envelopes the pipette tips. In the context of the present disclosure, relative terms like “top” and “bottom” are intended to be understood in view a typical use case where the bottom side of the base portion is facing down and its top side facing up. However, a box or a package according to the present disclosure can of course be positioned and oriented freely depending on the use case.

The hinge part may be in the form of a flexible hinge joining the base portion and the cover portion to each other. The cover portion and the base portion are able rotate relative to each other about an axis of rotation of the hinge. In particular, the hinge allows the cover portion to be swivelled between the open configuration and the closed configuration.

A first aspect of a box according to the present disclosure relates to ease of use of the box. For example, the hinge may be configured such that it requires only a small amount of force to operate. The cover may be opened by an angle larger than 90 degrees. Preferably, the hinge enables the cover to be turned open by at least 180 degrees. The cover may remain in the open configuration securely. In the context of use of a pipette and pipette tips, these functionalities are preferable as they allow an easy opening and closing of the box (even with one hand). Further, in an open configuration of the box, the cover portion does not block access to the interior of the box, and pipette tips can be easily picked from the box (even without touching or holding the box itself).

In some embodiments, the box comprises a locking part or shape to lock the cover in a closed configuration of the box. For example, the locking part or shape may be located inside the box in a closed configuration of the box so that the locking part or shape does not substantially (or at all) protrude from an outer surface of the box. The lock may be activated or closed by pressing the cover downwards, and/or the lock may be opened by a squeezing action, for example. The box may be configured such that it the cover can be locked and the locking can be released by one hand (or with a gripper). In some embodiments, the cover portion may be a detachable, lockable cover, preferably detachable by one hand.

A second aspect of a box according to the present disclosure is the form of the outer surface of the box. The outer surfaces of side walls of the box are preferably smooth without substantial protrusions. Thus, the hinge is preferably substantially flat. For example, the hinge may lay within an outer shape of the box in a closed configuration of the box such that it does not create substantial protrusions to the overall shape of the box in the closed configuration.

In some embodiments, in order to achieve a hinge with at least of some desired characteristics according to the first and second aspect above, the hinge may be formed of a piece of a flexible material has been at least partially embedded at least partially within the base portion and the cover portion. The hinge may be formed of a film material, such as a flexible film material. For example, the hinge may be formed of a plastic film material or Tyvek film. The hinge may also be formed of an elastomer material, such as a thermoplastic elastomer material. In some embodiments, the hinge is formed by a piece of adhesive tape attached to cover and base to join them together. The hinge may be made from a different material than the base portion and the cover portion.

In some embodiments, the hinge is prepared together with the rest of the box by means of In Mold Labeling (IML) technique. In some embodiments, the hinge is prepared together with the rest of the box by means of multicomponent injection moulding technique.

A third aspect of a box according to the present disclosure relates to sealability of the box. In applications where pipettes and pipette tips are being used, it is typically preferable to protect the pipette tips from contamination. To achieve this, the box may be sealed hermetically when the cover is in its closed configuration by means of the adhesive tape, for example. The box may be configured such that rims of the cover portion and the base portion interface with each other in the closed configuration. The box may comprise an adhesive tape running around at least a part of the circumference of the box and configured to seal a seam between the interfacing rims of the base and the cover. By using the adhesive tape, sufficient sealing can be achieved without plastic protective bags or pouches around the entire package. The tape provides a material-saving solution to protect the package and to make it hermetically tight. Further, the tape is easy to remove just prior to use.

In order to enable easy attachment of the adhesive tape and/or in order ensure that a good seal is being formed, the surfaces of the base portion and cover portion are preferably smooth around the seam between the two portions. In this context, the term “smooth” is intended to mean something that has a flat surface, i.e., a surface without significant bumps or protrusions, so that so that the adhesive tape can adhere to the surface for all the width of the tape. The smoothness of the seam can be maximized by using hinges as discussed earlier in relation to the second aspect of the present disclosure.

In some applications, a sealed box according to the present disclosure may become subject to thermal fluctuations (e.g., during sterilization and sealing processes of the box, and during transportation). The thermal fluctuations may cause an over-pressure within the sealed box that may lead to bulging of the box and/or detachment of the sealing tape. In order to prevent this, a pressure-evening or breathable filter may be incorporated to the box. In some embodiments, the adhesive tape running around the box may comprise a filter section. In some embodiments, a filter structure is formed to the body portion or the cover portion of the box. For example, a film type filter may be located on the bottom of the base portion of the box. The filter may be implemented, by using IML, ultrasound or thermal welding, for example. Also sintered filter could be used. In some embodiments, the filter could also be integrated to the sealing tape or the label. In this case, the label could be made out of Tyvek or medical paper, for example.

In some embodiments, there is a protective film, such as a shrink-wrap film, around the package. This protective film may be provided in replacement of or in addition to an adhesive tape sealing the box.

A fourth aspect of a box according to the present disclosure relates to storing and stacking of boxes and packages according to the present disclosure. In many applications, it is desirable to minimize space allocation of used pipette tip packages. A further advantage of have no substantial protrusions in the walls of the box is that it is easier to make the box nestable. In this context, the term “nestable box” is intended to be understood as a box having such shape and dimensions that allow a plurality of the boxes to be stacked on top of each other in such a way that each subsequent box is nested, i.e., at least positioned at least partially, preferably mostly, within the preceding box.

A fifth aspect of a box according to the present disclosure relates to its sustainability. In some embodiments, the box may not be reusable as it may be intended to be used as a light-weight single-use packaging for the pipette tips. The box may have a light weight construction, and because of this, it may be impossible to autoclave the box. However, even in such embodiments, materials of the box may be selected by emphasizing sustainability aspects. For example, bio-based materials, such as cellulose fibre reinforced plastic composites, may be used.

In the following paragraphs, we describe some exemplary embodiments of the invention. In all of these exemplary embodiments, the above-discussed five aspects are taken into account.

### Example 1

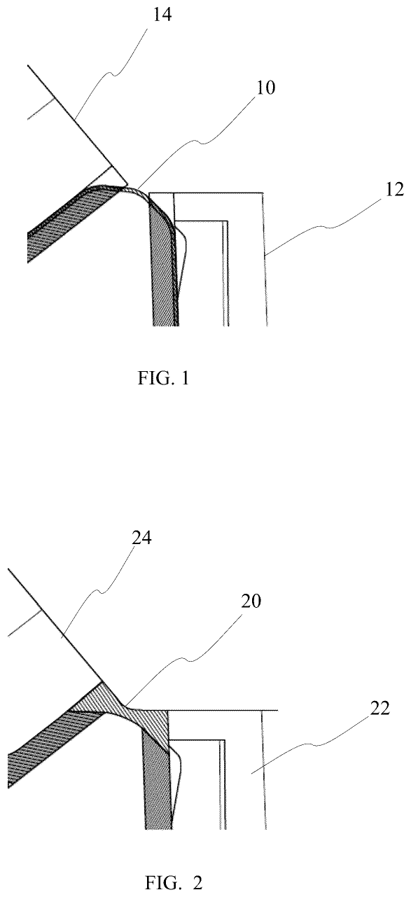

In an embodiment, IML (In Mold Labeling) injection molding technology is used for manufacturing and assembling the box and the hinge. FIG. 1 shows an embodiment in which the box comprises a flexible hinge 10 manufactured by IML process. The hinge 10 is made of a flexible sheet or film, has been at least partially embedded at least partially within the base portion 12 and the cover portion 14. The sheet or film may be a plastic film material or a fibrous film material. The fibrous film material may be for example Tyvek film or Paptic film, for example. The mold is constructed so that the flexible hinge part 10 can be mounted to the mold before closing the mold. The product that is obtained from the injection molding step, pushed out from the mold, is a ready package with the hinge assembled.

Advantages of this embodiment include minimal size of the package and material savings. The hinge mechanism is compact. IML process can be also used for providing the package with further properties. For example, a pressure-evening or breathable filter may be incorporated to a wall or bottom of the package. The filter part, such as a Tyvek film, may be pre-mounted to the mold before injection molding the package.

An IML film or part may be used for providing several functions or properties at the same time, such as a hinge function and a filter function. The IML film or part may be imprinted, which enables volume and model markings and for example generation of a desired design for the product. The IML film or part may cover the entire bottom face of the product or the entire cover of the product. Advantages of the IML process include space savings, material savings and user-friendliness.

### Example 2

In an embodiment, the flexible hinge is in the form of an elastomer hinge. For example, the hinge may be made of flexible thermoplastic elastomer material. The elastomer hinge may be realized by multicomponent injection moulding so that the cover, the base and the hinge form a unitary article during an injection moulding cycle. FIG. 2 shows a cross-sectional view of a hinge mechanism realized by multicomponent injection moulding. In FIG. 2, the hinge 20 is made of flexible thermoplastic elastomer material at least partially embedded at least partially within the base portion 22 and the cover portion 24.

Advantages of this embodiment include minimal size of the box and material savings. The elastomer hinge 20 is compact. Injection moulding of the elastomer component required by the hinge provides possibilities to integrate further properties to the box, for example a sealing zone, decorative coloured elements or gripping zones for a lock or to the bottom face of the box.

In some embodiments, the flexible hinge may be configured to breakable so as to enable tearing the cover. Additional shapes (e.g., perforations) may be provided in the hinge to facilitate or optimize tearing off of the cover. Thereafter, the cover may be used as a separate, detachable cover. In some embodiments with such separate cover, the box may be provided with additional locking means to enable attachement of the cover to the base of the box. Further, in embodiments where the box is configured to be nestable, tearing off the cover allows base portions and the cover portions of the box to be stacked separately.

### Example 3

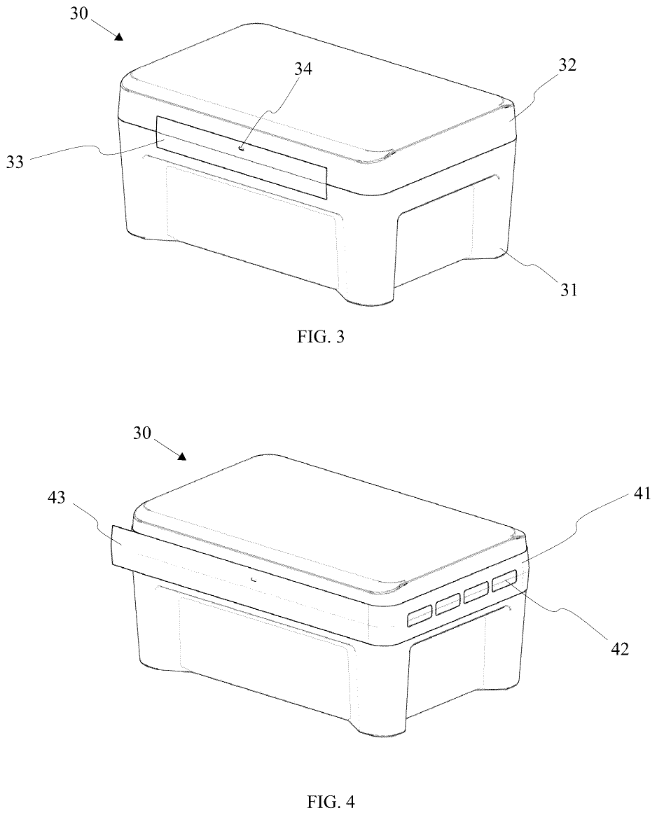

In an embodiment, the box comprises a hinge tape that functions as a hinge. FIG. 3 shows a hinge mechanism realized with an adhesive tape. In FIG. 3, a box 30 according to the present disclosure comprises a base portion 31 and a cover portion 32. The base portion 31 and the cover portion 32 are joined with a tape 33. The tape 33 acts as a flexible hinge between the base portion 31 and the cover portion 32. The tape 33 may comprise adhesive providing high adhesive bond strength. For example, the adhesive may be cured or cross-linked by radiation, UV light or oxygen. Upon application of the tape, proper formation of an adhesive joint may be ensured by additional thermal welding or heat sealing or ultrasound welding. When using welding methods, the tape may comprise adhesive-free zones adapted for being treated by said welding.

In some embodiments, the hinge is provided with a remotely readable tag 34, such as a RFID tag. The remotely readable tag may also be embedded within the base portion 31 or the cover portion 32. The remotely readable tag may be used for providing each box with a unique identifier and/or information regarding intended contents of the box.

### Example 4

In some embodiments, the box according to the present disclosure may be hermetically sealed by means of an adhesive tape that runs around the box, along the seam between the cover and the base. FIG. 4 shows an embodiment in which a tape 41 runs along and above the seam between the cover and the base of a box according to the present disclosure. The box may be the same or similar as in Examples 1-3, for example. The tape forming the flexible hinge (hinge 33 in FIG. 3) is preferably thin enough to enable application of the hermetically sealing tape 41. While the hermetically sealing adhesive tape is being discussed in view of Examples 1-3, its use is not limited only to those examples. Instead, the tape can be used in all boxes according to the present disclosure.

As shown in FIG. 4, a filter 42 may also be integrated to the sealing tape 41 or the label. In this case the label could be made out of Tyvek or medical paper. Further, a sterilization indicator, for example a radiation sterilization indicator or a steam sterilization indicator, may be integrated in the tape 41.

### Example 5

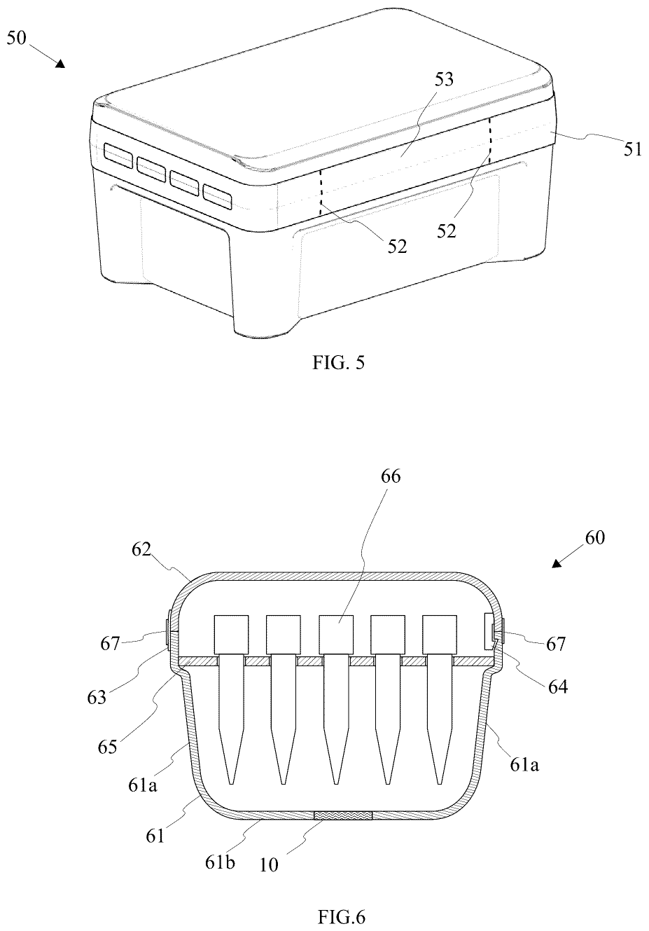

FIG. 5 shows an embodiment in which a box 50 according to the present disclosure comprises a tape 51 which functions both as a hermetic sealing and as a flexible hinge. The tape 51 comprises pre-cut perforations 52 or notch shapes in positions at which the tape can be cut off in a controlled way upon removal of tape 51. After the removal of tape, a remaining portion 53 of the tape 51 may act as a flexible hinge. An advantage of pre-cutting is that a portion 53 of adhesive tape used as the hinge can be optimized with regard to adhesive bond strength. Additionally, adhesive-free zones, for example as described above in Example 3, may be left at the portion of the tape 51 configured to form the remaining portion 53 in order to enable thermal welding or ultrasound welding in those zones.

Control of hermetic sealing of the box may be carried out for example in the following ways in manufacturing: The box is soaked in water that is warmer than the product and subsequent monitoring of bubbles. Alternatively, or in addition, automated vacuum testing may be carried out through a filter zone adapted to even out pressure differences, wherein said filter zone is integrated in the product. In this alternative, a sucker-type gripper is attached to the breathable filter zone by a sucking action. By monitoring air flow through the filter zone, it is possible to observe a leakage. In this way it may be possible to carry out reliable testing of the hermetic closure by the tape.

### Example 6

The present disclosure also describes a package of disposable pipette tips, comprising a box according to the present disclosure, and a plurality of disposable pipette tips inside the box. One example of such a package is presented in FIG. 6 where a cross-sectional view of the package is shown.

In FIG. 6, the package 60 comprises a box according to the present disclosure. The box comprises a base portion 61 and a cover portion 62. The base portion 61 and/or the cover portion 62 may be manufactured using thin wall injection molding, for example. In FIG. 6, the box 60 comprises a flexible hinge 63. The flexible hinge 63 be implemented by using a film, preferably using an adhesive tape.

In some embodiments of the package 60, at least the base portion 61 is formed to be nestable. The shape of the base portion may be configured such that a plurality of such base portions can be nestably stacked after use to minimize waste space allocation. For example, in FIG. 6, the walls 61a of a base portion 61 taper towards the bottom 61b of the base portion 61.

In FIG. 6, the package 60 further comprises a tray 65 for pipettes tips inside the package. This tray may be in the form of a rack with a matrix of holes into which individual pipette tips 66 are positioned. The tray 65 in FIG. 6 is positioned completely within the container and it does not have bulky mounting hooks or mounting extensions that engage with the rim of the base portion 61 and/or protrude from the outer surface of the box. In this manner, the smooth outer surface can be maintained. Further, such mounting hooks or extensions may be problematic when using in multichannel pipettes. In FIG. 6, the tray 65 rests on ridges or steps arranged on the inside walls of the base portions 61. The tray 65 and the base portion may be configured such that tray 65 can be removed from the box by squeezing the base portion 65.

FIG. 6 also shows a sealing tap 67 running around the box at the seam between the cover portion 62 and the base portion 61 in order to seal the box. The sealing tape is preferably semi-rigid in order to make it easier to peel it off.

As discussed earlier, it may be desirable to include a filter to a sealed package in order to equalize pressure inside the box. Alternatively, or in addition, the filter may be used for finding possible leaks in the sealing of the package. In FIG. 6, a film type filter is located on the bottom of the base portion of the box. The filter may be implemented, by using IML, ultrasound or thermal welding, for example. Also sintered filter could be used.

As mentioned earlier, a box according to the present disclosure may comprise a locking mechanism. Preferably, the lock is constructed so that all parts of the lock remain inside the package, i.e., inside the outer surfaces of the package when the cover has been locked to a closed configuration. In FIG. 6, an exemplary lock mechanism is shown. The locking mechanism comprises a locking claw 64 on the inside surface at the rim of the cover portion 62. In a closed configuration of the box. the locking claw 64 engages with a complementing locking slot or a recess in the base portion 61. The locking mechanism can be opened by pressing the outer surface of the cover portion 62 at the location of the locking claw 64, thereby causing the locking claw to disengage from the locking slot. The lock can be operated (opened and closed) with one hand, or with a gripper. In FIG. 6, the locking mechanism has been realized without any protruding shapes in the zone covered by the tape. This kind of lock can be used in a box according to the present disclosure, including all examples 1-5.

In some embodiments, two locks can be provided and positioned on opposite sides of the cover. The cover may be detached entirely from the hinge mechanism and subsequently placed back on the package and pressed to a closed and locked configuration. Said detaching may be carried out for example by squeezing from the sides of the cover or alternatively by pulling the cover. The lock that is located on the same side as the hinge may be constructed so that cover opening action is not impaired, as a result of the geometry of the cover opening movement and the lever effect.

In all above discussed embodiments, the cover can be opened by at least 180 degrees. Further, the cover portion can be easily opened and closed, and it remains in its open configuration without a need to hold it open. In addition, the embodiments can be implemented with minimal protrusions on the outer surface of the box.

Materials of the box in a package according to all Examples 1-6 and, more generally, all boxes according to the present disclosure may be selected by emphasizing sustainability aspects. For example, bio-based materials, such as cellulose fibre reinforced plastic composites, may be used.

While the present disclosure mostly discusses embodiments with flexible hinges, a compact version of a traditional rigid two-part hinge structure may also be used. In this kind of implementations, a minimal protrusion of the hinge can be achieved when the hinge axis is positioned in the same plane with the outer surface of the box or only slightly offset from the outer surface. The hinge may have a snap-together structure (e.g., with a ball and cup interface) allowing the cover portion to be easily detached and reattached.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present invention is industrially applicable at least in boxes and packages for disposable laboratory consumables.

1. A box for disposable pipette tips, comprising:
a base portion forming a container to receive the pipette tips therein;
a cover portion movable to a closed configuration where the cover portion closes the base portion into a closed container; and
a flexible hinge joining the base portion and the cover portion to each other.

2. The box according to claim 1, wherein the hinge lies substantially within an outer shape of the box in the closed configuration such that the hinge does not create substantial protrusions to the overall shape of the box in the closed configuration.

3. The box according to claim 1, wherein the box comprises a locking part or shape to lock the cover in the closed configuration, the locking part or shape being located inside the box in the closed configuration such that the locking part or shape does not substantially protrude from an outer surface of the box.

4. The box according to claim 1, wherein the cover is in the closed configuration, and the box further comprises
an adhesive tape running around at least a part of the circumference of the box and
configured to seal the respective interface between the base and the cover.

5. The box according to claim 4, wherein the adhesive tape comprises a filter section configured to equalize air pressure within the box.

6. The box according to claim 1, wherein the box is in the form of a nestable box.

7. The box according to claim 1, wherein the base portion comprises a filter assembly configured to equalize air pressure within the box.

8. The box according to claim 1, wherein the hinge is formed of a piece of a flexible material has been at least partially embedded at least partially within the base portion and the cover portion.

9. The box according to claim 1, wherein the hinge is formed of a plastic film material or a Tyvek film.

10. The box according to claim 1, wherein the hinge is formed of an elastomer material, such as a thermoplastic elastomer material.

11. The box according to claim 10, wherein the hinge is configured to be manually tearable so that the cover portion becomes separated from the base portion.

12. The box according to claim 1, wherein the hinge is formed by a piece of adhesive tape.

13. The box according to claim 1, wherein the hinge is prepared together with the rest of the box by means of In Mold Labeling (IML) technique.

14. The box according to claim 1, wherein the hinge is prepared together with the rest of the box by means of multicomponent injection moulding technique.

15. A package of disposable pipette tips, comprising
a box according to claim 1; and
a plurality of disposable pipette tips inside the box.
